(19) United States
(12) Patent Application Publication
(10) Pub. No.: US 2013/0120107 A1
(43) Pub. Date: May 16, 2013

(54) METHODS AND SYSTEMS FOR PROGRAMMING AN ELECTRIC MACHINE

(71) Applicants: Wei Song, Fort Wayne, IN (US); Norman C. Golm, JR., Fort Wayne, IN (US)

(72) Inventors: Wei Song, Fort Wayne, IN (US); Norman C. Golm, JR., Fort Wayne, IN (US)

(21) Appl. No.: 13/295,695

(22) Filed: Nov. 14, 2011

(51) Int. Cl. G05B 19/02; G06F 1/16

(52) U.S. Cl. 340/4.3; 361/679.02

(57) ABSTRACT

A programming module and method of programming an electric machine is described. The programming module includes a housing defining an exterior and an interior of the programming module, a plurality of terminals biased to extend at least partially from the exterior of the housing, and a processing device electrically coupled to the plurality of terminals and configured to provide a programming signal to at least one of the plurality of terminals.

### BACKGROUND OF THE INVENTION

The embodiments described herein relate generally to an electric machine, and more specifically, to programming of a motor controller associated with the electric machine.

A motor controller typically includes a memory that stores a program used to control operation of a corresponding electric machine. The motor controller includes a connection port that can be coupled to, for example, a cable, which provides data from a host for programming the motor controller. During the manufacture of the motor controller, the cable is physically coupled to the connection port for programming and testing of the motor controller. Although each motor controller is connected only once to the host during manufacturing, the cable may be coupled and uncoupled from hundreds of motor controllers each day. Repeated coupling and uncoupling of the cable shortens the useful life of the cable.

### BRIEF DESCRIPTION OF THE INVENTION

In one aspect, a programming module is provided. The programming module includes a housing defining an exterior and an interior of the programming module, a plurality of terminals biased to extend at least partially from the exterior of the housing, and a processing device electrically coupled to the plurality of terminals and configured to provide a programming signal to at least one of the plurality of terminals.

In another aspect, a method for programming a motor controller is provided. The method includes removably coupling a programming module to the motor controller, wherein the programming module includes a wireless communication device. The method also includes receiving, at the wireless communication device, a programming signal and conditioning the programming signal for application to the motor controller. The method also includes providing the programming signal to the motor controller.

### BRIEF DESCRIPTION OF THE DRAWINGS

FIG. 1 is a side view of an exemplary electric motor that includes, or is coupled to, a motor controller.

FIG. 2 is a side view of an interior of the electric motor shown in FIG. 1.

FIG. 3 is a diagram of an exemplary programming module configured for coupling with the motor controller shown in FIG. 1.

FIG. 4 is a block diagram of an exemplary system for programming the electric motor shown in FIG. 1.

FIG. 5 is a flow chart of an exemplary method for programming the electric motor shown in FIG. 1.

### DETAILED DESCRIPTION OF THE INVENTION

The methods, systems, and apparatus described herein facilitate programming of a motor controller. An interface described herein provides communication between a remote host and the motor controller and may allow multiple motor controllers to be programmed simultaneously by one remote host. The methods, systems, and apparatus described herein may also facilitate programming the motor controller locally, without a connection to a remote host. Furthermore, the methods, systems, and apparatus described herein reduce wear on a connector used to couple the motor controller to a host.

Technical effects of the methods, systems, and apparatus described herein include at least one of: (a) removably coupling a programming module to a motor controller, wherein the programming module includes a wireless communication device; (b) receiving, at the wireless communication device, a programming signal; (c) conditioning the programming signal for application to the motor controller; and (d) providing the programming signal to the motor controller.

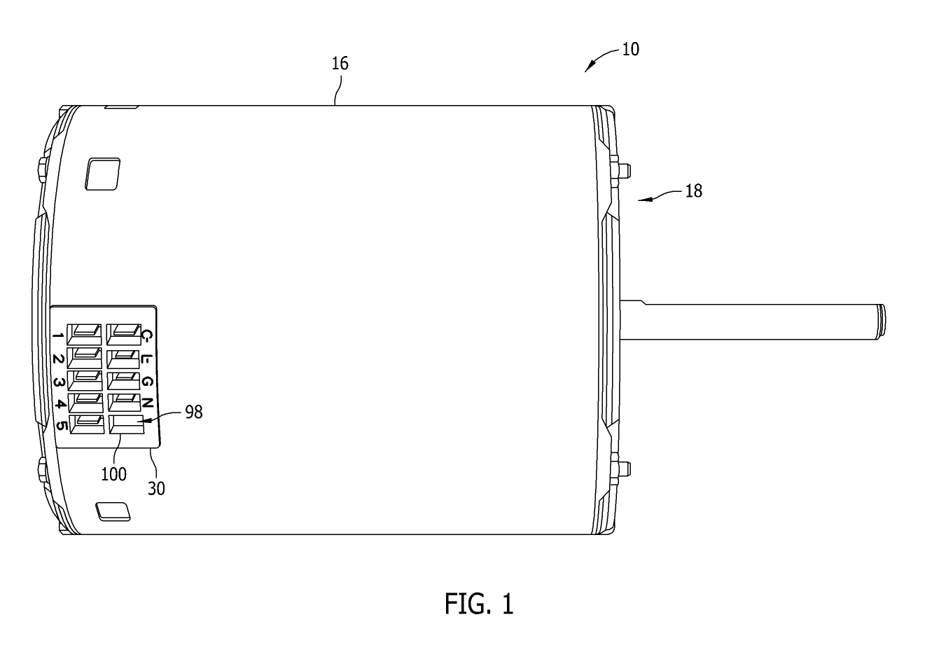

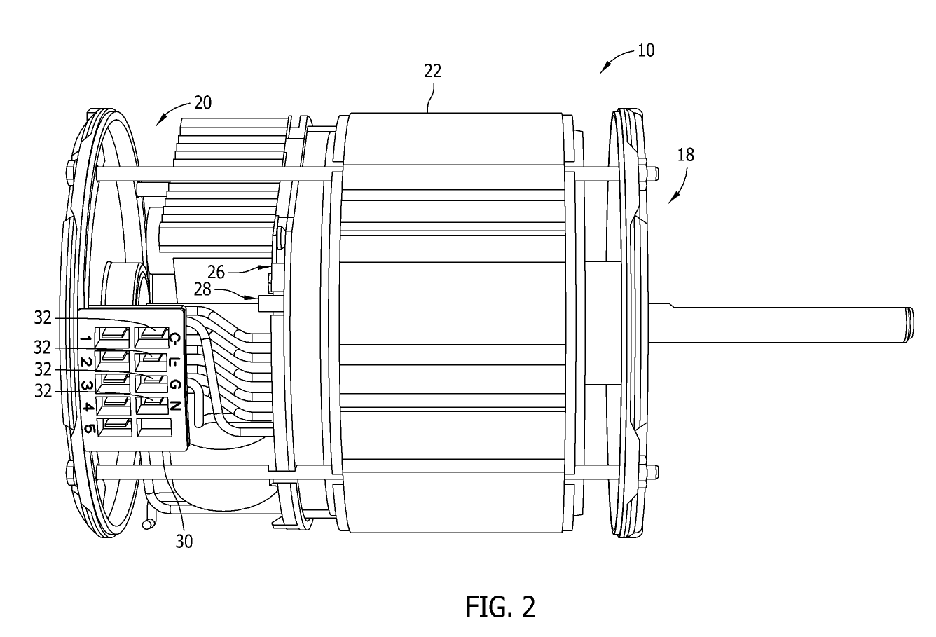

FIG. 1 is a side view of an exemplary electric motor 10. Although described herein as electric motor 10, the methods, systems, and apparatus described herein are also applicable to other electric machines, for example, electric generators. In the exemplary embodiment, electric motor 10 includes a motor housing 16 that defines an interior (not shown in FIG. 1) and an exterior 18 of motor 10. FIG. 2 is a side view of electric motor 10 with motor housing 16 removed to show interior 20 of motor 10. In the exemplary embodiment, motor 10 includes a stationary assembly 22 and a rotatable assembly (not shown). Motor housing 16 is configured to at least partially enclose and protect the stationary and rotatable assemblies. In the exemplary embodiment, electric motor 10 also includes a motor controller 26, enclosed at least partially within motor housing 16. Although illustrated as included within motor housing 16, motor controller 26 may be included within a separate housing and electrically coupled to the stationary assembly and/or the rotatable assembly.

In the exemplary embodiment, motor controller 26 includes, or is coupled to, a memory device 28, configured to store motor operating instructions and/or motor operating data. Motor controller 26 provides operating signals used to control operation of electric motor 10, for example, but not limited to, a sine wave operating signal, a square wave operating signal, or any other suitable operating signal that allows electric motor 10 to function as described herein. The operating signals are based at least partially on the stored motor operating instructions and direct operation of electric motor 10.

In the exemplary embodiment, motor controller 26 is programmable. Motor 10 includes an input/output connector 30 through which an external programming device (e.g., a programming host) may be communicatively coupled to motor controller 26. For example, input/output connector 30 may include a plurality of terminals 32 accessible from exterior 18 of motor housing 16. Plurality of terminals 32 may extend from exterior 18 of motor housing 16 and/or may be recessed beneath exterior 18 of motor housing 16. Terminals 32 may include blades configured to be coupled with a corresponding connector to electrically couple motor controller 26 to an external programming host. The programming host may include a computer configured to be coupled to motor controller 26 for programming of motor controller 26. Connector 30 receives a corresponding connector that is also coupled to the external programming host and receives/transmits programming signals from/to the external programming host. Connector 30 may be included in a serial connection between motor controller 26 and the programming host. For example, data may be transmitted between the programming host and motor controller 26 using a universal asynchronous receiver/transmitter (UART) using an RS-232 protocol.

Electric motor 10 may be any electric motor that includes, or is coupled to, a motor controller for controlling operation of the motor. For example, electric motor 10 may include, but is not limited to, a brushless direct current (BLDC) motor, a brushless alternating current (BLAC) motor, and/or a reluctance motor. Electric motor 10 may be referred to as an electronically commutated motor (ECM).

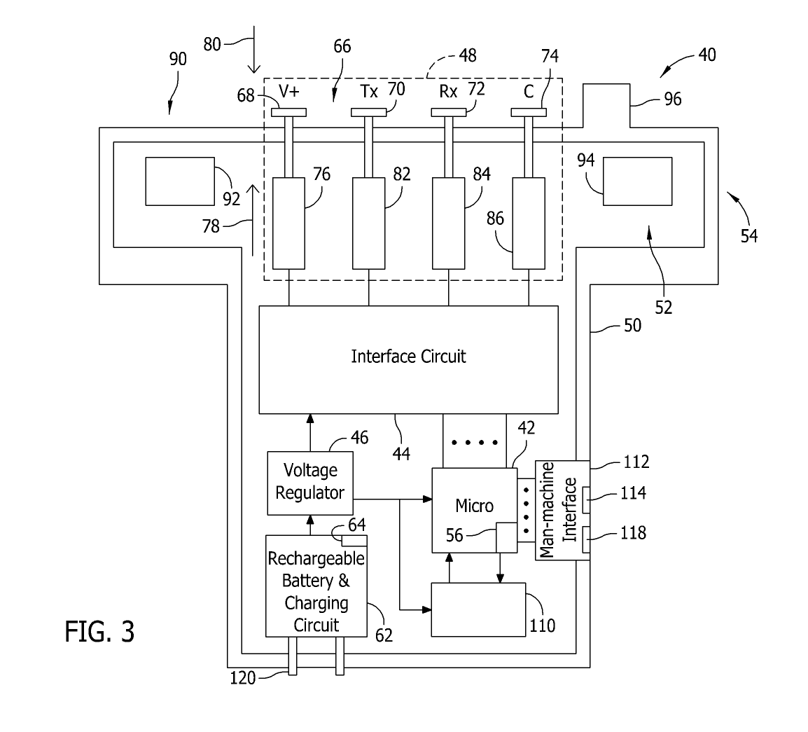

FIG. 3 is a diagram of an exemplary programming module 40. Programming module 40 is configured for coupling with electric motor 10 (shown in FIG. 1) and for providing programming instructions to motor controller 26 (shown in FIG. 2) for storage within memory device 28 (shown in FIG. 2). In the exemplary embodiment, programming module 40 includes a processing device 42, an interface circuit 44, a voltage regulator 46, and at least one connector 48. In the exemplary embodiment, processing device 42, interface circuit 44, voltage regulator 46, and connector 48 are included at least partially within a module housing 50. Module housing 50 defines an interior 52 of programming module 40 and an exterior 54 of programming module 40. In the exemplary embodiment, processing device 42 includes, or is coupled to, a memory device 56 that stores, for example, programming information to be transmitted to motor controller 26.

In the exemplary embodiment, programming module 40 also includes a charging circuit 62 and an energy storage device 64 enclosed at least partially within module housing 50. In the exemplary embodiment, energy storage device 64 includes at least one battery. In an alternative embodiment, charging circuit 62 and energy storage device 64 are external to module housing 50 and electrically coupled to voltage regulator 46.

The term processing device, as used herein, refers to central processing units, microprocessors, microcontrollers, reduced instruction set circuits (RISC), application specific integrated circuits (ASIC), logic circuits, and any other circuit or processor capable of executing the functions described herein. The term “processing device” as that term is used herein, is intended to denote any machine capable of performing the calculations, or computations, necessary to perform the tasks described herein. The term “processing device” also is intended to denote any machine that is capable of accepting a structured input and of processing the input in accordance with prescribed rules to produce an output. It should also be noted that the phrase “configured to” as used herein means that the processing device is equipped with a combination of hardware and software for performing the tasks described herein, as will be understood by those skilled in the art.

In the exemplary embodiment, connector 48 includes a plurality of terminals 66 that are biased to at least partially extend from interior 52 to exterior 54 of module housing 50. For example, terminals 66 may include, but are not limited to, a first terminal 68, a second terminal 70, a third terminal 72, and a fourth terminal 74. Connector 48 is configured for coupling with an input/output connector of a motor, for example, input/output connector 30 (shown in FIG. 1). For example, each of terminals 66 may include a pogo pin. More specifically, in the exemplary embodiment, first terminal 68 is a pogo pin that includes a biasing device 76 that exerts a force in a first direction 78 on first terminal 68 in response to an opposite force in a second direction 80 applied to first terminal 68 by one of terminals 32 (shown in FIG. 1).

Force in first direction 78 pushes first terminal 68 from interior 52 toward exterior 54 and force in second direction 80 pushes first terminal 68 from exterior 54 toward interior 52 of module housing 50. In other words, biasing device 76 maintains a connection between terminals 66 of connector 48 and terminals 32 of input/output connector 30 with zero insertion force. A typical connection between a male connector (i.e., a blade) and a corresponding female connector requires insertion force and eventually causes wear to the male and/or female connector. By eliminating the insertion force, the usable life of connector 48 is increased. Similarly, in the exemplary embodiment, second terminal 70 is a pogo pin that includes a biasing device 82, third terminal 72 is a pogo pin that includes a biasing device 84, and fourth terminal 74 is a pogo pin that includes a biasing device 86. Moreover, in some embodiments, terminals 32 of input/output connector 30 are recessed within motor housing 16 and connector 48 is configured to extend into motor housing 16 in order to provide contact between terminals 66 and terminals 32.

In the exemplary embodiment, to maintain a connection between programming module 40 and electric motor 10, and more specifically, between terminals 66 of connector 48 and corresponding terminals 32 of input/output connector 30, programming module 40 includes at least one magnetic device 90. For example, magnetic device 90 may include a first permanent magnet 92 and a second permanent magnet 94. First and second permanent magnets 92 and 94 are magnetically attracted to a metal housing, for example, motor housing 16 (shown in FIG. 1), and therefore, removably couple programming module 40 to electric motor 10 by magnetic force. Programming module 40, and more specifically, terminals 68, 70, 72, and 74, are configured such that when programming module 40 is magnetically coupled to motor housing 16, biasing devices 76, 82, 84, and 86 are depressed, providing the biasing force that presses terminals 66 of connector 48 against corresponding terminals 32 of input/output connector 30.

In the exemplary embodiment, module housing 50 includes a key member 96. In the exemplary embodiment, key member 96 extends from external 54 surface of module housing 50 and is configured to interact with a complementary key member 98 (shown in FIG. 1) included in motor 10. Key member 98 may include a recess within, for example, motor housing 16 and/or input/output connector 30. For example, key member 98 may include a space defined between adjacent terminals of input/output connector 30, a space defined between a terminal of input/output connector 30 and an end 100 of input/output connector 30, and/or an opening defined within input/output connector 30 that does not include a terminal blade. Key member 96 is configured to extend into key member 98. Key member 96 and complementary key member 98 ensure that connector 48 is correctly aligned with input/output connector 30. Key members 96 and 98 also facilitate rapid coupling of programming module 40 and electric motor 10 by providing a user with a visible alignment aid and by providing only one direction in which programming module 40 can be coupled to, and remain coupled to, electric motor 10.

In the exemplary embodiment, programming module 40 also includes a wireless device 110. Wireless device 110 provides a wireless communication connection between programming module 40 and a remote host. For example, the remote host may wirelessly transmit programming instructions to programming module 40, for transmission to motor controller 26. Wireless device 110 may be configured for radio frequency (RF) communication between programming module 40 and the remote host. Alternatively, wireless device 110 may be configured to use wireless standards including, but not limited to, 2G, 3G, and 4G cellular standards such as LTE, EDGE, and GPRS, IEEE 802.16 Wi-Max, IEEE 802.15 ZigBee®, Bluetooth, IEEE 802.11 standards including 802.11a, 802.11b, 802.11d, 802.11e, 802.11g, 802.11h, 802.11i, 802.11j, and 802.11n, Wi-Fi®, and proprietary standards such as Z-Wave®. Wi-Fi® is a certification mark developed by the Wi-Fi Alliance, ZigBee® is a registered trademark of ZigBee Alliance, Inc. of San Ramon, Calif., and Z-Wave® is an identity mark of the Z-Wave Alliance of Milpitas, Calif.

In an alternative embodiment, programming instructions are stored within memory device 56. Storing the programming instructions that will be transmitted to motor controller 26 for programming of motor controller 26 allows programming module 40 to function independently from the remote host. In other words, storing programming instructions in memory device 56 allows local programming of motor controller 26 where programming module 40 acts as the host.

In the exemplary embodiment, programming module 40 may also include a man-machine interface 112. Man-machine interface 112 may include at least one connector 114 configured for coupling with an interface cable (not shown in FIG. 3). In the exemplary embodiment, man-machine interface 112 receives programming data from an external source (not shown in FIG. 3), for example, a centralized computer system, which is then stored in memory device 56.

Man-machine interface 112 may also include an input/output device 118 that displays information to a user of programming module 40 and/or receives information from the user. For example, input/output device 118 may include at least one status indicator (e.g., a light emitting diode (LED)) that displays a status indication to the user. The status indication may include, but is not limited to including, a transmitting data indicator, a receiving data indicator, a power on/off indicator, an error signal indicator, and a connection established indicator. For example, the LED may be illuminated in a specific color that indicates to the user that programming module 40 is transmitting data to motor controller 26. Furthermore, the LED may be illuminated in a different color that indicates to the user that programming module 40 is receiving data from motor controller 26. The LED may also provide information to the user regarding the level of energy stored within battery 64, for example, the LED may provide a low-battery warning to the user of programming module 40. Moreover, input/output device 118 may include at least one input device (e.g., a button) that allows the user to select from programming module commands to locally activate programming of motor controller 26, select the program to be transmitted to motor controller 26, and/or initiate receiving information from motor controller 26.

In the exemplary embodiment, charging circuit 62 and battery device 64 provide power to voltage regulator 46. The power provided to voltage regulator 46 is at a level that facilitates proper operation of components within programming module 40, for example, but not limited to, interface circuit 44, processing device 42, and/or wireless device 110. In the exemplary embodiment, charging circuit 62 includes at least one terminal 120 configured to couple with an external source of power (not shown in FIG. 3). Power from the external source of power may be used to power programming module 40 and/or to recharge battery 64. Charging circuit 62 controls recharging of battery 64, for example, by selectively providing power provided from the external source of power to battery 64. Charging circuit 62 may also convert the power provided from the external source to a suitable power for charging of battery 64.

In the exemplary embodiment, voltage regulator 46 controls the voltage of the power provided to components within programming module 40. For example, voltage regulator 46 may provide power having a first voltage level to interface circuit 44 and power having a second voltage level to processing device 42. Furthermore, as programming module 40 is operated, and the energy stored within battery 64 decreases, voltage regulator 46 provides a first substantially constant voltage to interface circuit 44 and a second substantially constant voltage to processing device 42.

In the exemplary embodiment, interface circuit 44 conditions signals transmitted between processing device 42 and motor controller 26. For example, interface circuit 44 may include a boost circuit and/or driver that increases signals provided by processing device 42, for example, increases a current level of signals provided by processing device 42, to a level that allows the signals to be transmitted to motor controller 26. In this example, motor controller 26 may be electrically isolated from devices coupled to input/output connector 30 by an isolation device, for example, an optocoupler. Such an isolation device protects programming module 40 from the high currents/voltages used to operate motor 10. Interface circuit 44 provides signals having a current level that is high enough that the signal may be converted to light by the optocoupler. In the exemplary embodiment, interface circuit 44 also reduces signals received from connectors 48 to a level that will not damage processing device 42. For example, interface circuit 44 may reduce a voltage level of signals received from connector 48 to between approximately 0 to 5 volts, and more specifically, to between approximately 0 to 3 volts.

Moreover, in the exemplary embodiment, programming module 40 may receive a signal from motor controller 26. For example, the signal may include operating data/statistics collected and stored within memory device 28. A user may download the operating data/statistics from motor 10 using programming module 40 for data logging and analysis of motor operation.

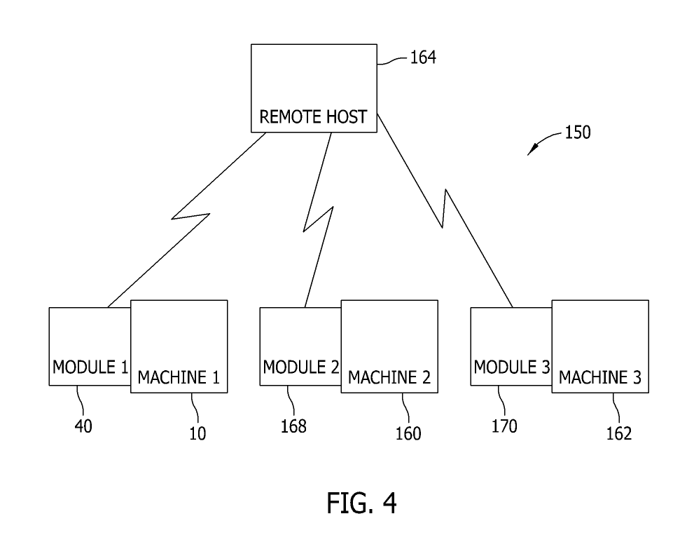

FIG. 4 is a block diagram of an exemplary system 150 for programming electric motors. In the exemplary embodiment, system 150 facilitates programming a first motor, for example, electric motor 10 (shown in FIG. 1), a second motor 160, and a third motor 162. In the exemplary embodiment, system 150 includes a remote host 164 configured for programming of electric motor controllers. System 150 also includes a first programming module, for example, programming module 40 (shown in FIG. 3), a second programming module 168, and a third programming module 170. Remote host 164 and modules 40, 168, and 170 include wireless communication devices that facilitate wireless communication between remote host 164 and electric motors 10, 160, and 162. By coupling modules 40, 168, and 170 to motors 10, 160, and 162, respectively, remote host 164 simultaneously programs motors 10, 160, and 162. Furthermore, since the communication connection between remote host 164 and modules 40, 168, and 170 is wireless, motors 10, 160, and 162 may be physically moved without interrupting the programming process.

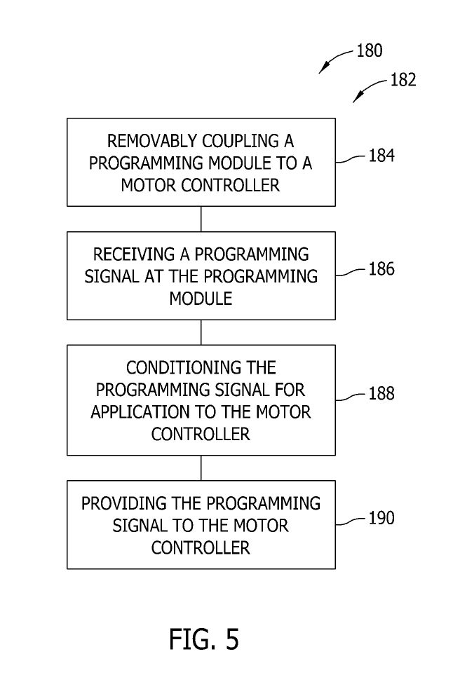

FIG. 5 is a flow chart 180 of an exemplary method 182 for programming an electric motor, for example, electric motor 10 (shown in FIG. 1). In the exemplary embodiment, method 182 includes removably coupling 184 a programming module, for example, programming module 40 (shown in FIG. 3), to a motor controller, for example, motor controller 26 (shown in FIG. 1), wherein programming module 40 includes a wireless communication device, for example, wireless communication device 110 (shown in FIG. 3). Wireless communication device 110 provides a communication connection between programming module 40 and a remote programming host, for example, remote host 164 (shown in FIG. 4). Programming module 40 includes a biased connector, for example, biased connector 48 (shown in FIG. 3) that is aligned with an input/output connector, for example, input/output connector 30 (shown in FIG. 1), of motor controller 26. Furthermore, programming module 40 may be magnetically coupled to a motor housing, for example, motor housing 16, that encloses motor controller 26.

In the exemplary embodiment, method 182 also includes receiving 186, from remote host 164, a programming signal at programming module 40. For example, programming module 40 may receive 186 the programming signal via a wireless communication device, for example, wireless communication device 110, included within programming module 40.

In the exemplary embodiment, method 182 also includes conditioning 188 the programming signal for application to motor controller 26. For example, an interface circuit, for example, interface circuit 44 (shown in FIG. 3) of programming module 40 may increase a current level of the programming signal from a first level provided by processing device 42 to a second level for application to motor controller 26. Interface circuit 44 may also reduce a current level of a signal received from motor controller 26 before the signal is provided to processing device 42.

In the exemplary embodiment, method 182 also includes providing 190 the programming signal to motor controller 26. Motor controller 26 stores the programming data contained within the programming signal for use in controlling operation of electric motor 10.

Described herein are exemplary methods, systems, and apparatus for programming a motor controller. More specifically, the methods, systems, and apparatus described herein enable programming of the motor controller without physical tethering of the motor to a programming host. Wireless communication provided by the methods, systems, and apparatus described herein facilitate simultaneous programming of multiple motor controllers, each coupled to a programming module, by a remote host. The host may be situated remotely from the motor being programmed and the motor may be moved during programming. The apparatus described herein facilitates easy coupling of the host and motor being programmed using magnetic force and a key member. Furthermore, a connector that includes pogo pins facilitates zero force coupling of the connector and the motor controller. Memory included within the apparatus described herein facilitates local programming of the motor controller where the apparatus itself acts as the host.

The methods, systems, and apparatus described herein facilitate efficient and economical programming of an electric motor. Exemplary embodiments of methods, systems, and apparatus are described and/or illustrated herein in detail. The methods, systems, and apparatus are not limited to the specific embodiments described herein, but rather, components of each apparatus and system, as well as steps of each method, may be utilized independently and separately from other components and steps described herein. Each component, and each method step, can also be used in combination with other components and/or method steps.

When introducing elements/components/etc. of the methods and apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A programming module comprising:
a housing defining an exterior and an interior of said programming module;
a plurality of terminals biased to extend at least partially from the exterior of said housing; and
a processing device electrically coupled to said plurality of terminals and configured to provide a programming signal to at least one of said plurality of terminals.

2. A module in accordance with claim 1, wherein said processing device includes and/or is coupled to a memory device configured to store programming data associated with at least one motor controller.

3. A module in accordance with claim 1, further comprising a wireless communication device positioned at least partially within said housing and electrically coupled to said processing device, said wireless communication device configured to communicate with a remote host.

4. A module in accordance with claim 3, wherein said wireless communication device comprises at least one of a radio frequency (RF) circuit, a Bluetooth circuit, and a Zigbee circuit.

5. A module in accordance with claim 1, further comprising an input/output device coupled to said processing device and configured to receive an input from a user and display a status indication to the user.

6. A module in accordance with claim 5, wherein the status indication comprises at least one of a transmitting data indicator, a receiving data indicator, a power on/off indicator, an error signal indicator, a connection established indicator, and a battery-status indicator.

7. A module in accordance with claim 1, further comprising at least one of a direct current (DC) power source and an interface circuit, said interface circuit coupled between said plurality of terminals and said processing device.

8. A module in accordance with claim 7, wherein said interface circuit is configured to:
receive a signal from at least one of said plurality of terminals;
condition the signal; and
provide the conditioned signal to said processing device.

9. A module in accordance with claim 7, wherein said interface circuit is configured to:
receive a signal from said processing device;
condition the signal; and
provide the conditioned signal to at least one of said plurality of terminals.

10. A module in accordance with claim 7, wherein said DC power source comprises a rechargeable battery and a charging circuit.

11. A module in accordance with claim 7, further comprising a voltage regulator coupled between said DC power source and at least one of said interface circuit and said processing device, said voltage regulator configured to condition power received from said DC power source and to provide the conditioned power to at least one of said processing device and said interface circuit.

12. A module in accordance with claim 1, further comprising at least one magnetic device configured to attract said programming module to a metal component of the electric machine and maintain a position of the programming module with respect to the electric machine.

13. A module in accordance with claim 1, wherein said plurality of terminals comprise pogo pins, wherein each pogo pin is configured to move with respect to said housing and is biased to push away from the exterior of said housing.

14. A module in accordance with claim 1, wherein said housing comprises a first key member configured to interact with a complementary second key member associated with the electric machine to ensure proper alignment of said programming module with respect to the electric machine.

15. A module in accordance with claim 14, wherein said first key member comprises a protrusion extending from the exterior of said housing and said second key member comprises a complementary recess included within a housing of the electric machine, wherein said first key member is configured for positioning within said second key member.

16. A method for programming a motor controller comprising:
removably coupling a programming module to the motor controller, wherein the programming module includes a wireless communication device;
receiving, at the wireless communication device, a programming signal;
conditioning the programming signal for application to the motor controller; and
providing the programming signal to the motor controller.

17. A method in accordance with claim 16, wherein conditioning the programming signal comprises increasing a current level of the programming signal from a first level provided by the processing device to a second level for application to the motor controller, wherein the second current level allows the programming signal to be transmitted to the motor controller through an optocoupler.

18. A method in accordance with claim 16, wherein removably coupling the programming module to the motor controller comprises aligning a biased connector extending from the programming module with an input/output connector of the motor controller.

19. A method in accordance with claim 16, wherein removably coupling the programming module to the motor controller comprises magnetically coupling the programming module to a motor housing that encloses the motor controller.

20. A method in accordance with claim 16, wherein receiving, at the wireless communication device, a programming signal comprises receiving the programming signal from a remote host using radio frequency (RF) communication.
